(19) United States
(12) Patent Application Publication
(10) Pub. No.: US 2006/0229484 A1
(43) Pub. Date: Oct. 12, 2006

(54) Potentially hazardous material management methods and apparatuses

(75) Inventors: Tim Dore, Lake Oswego, OR (US); Mark Wysong, Lake Oswego, OR (US); Mark Heins, Lake Oswego, OR (US); Eric Danylieko, Lake Oswego, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Dolphin Software, Inc.

(21) Appl. No.: 11/090,392

(22) Filed: Mar. 25, 2005

(51) Int. Cl. G21F 9/00

(52) U.S. Cl. 588/1

(57) ABSTRACT

An apparatus is provided with instructions adapted to present aggregated or averaged data associated with potentially hazardous material management of a number of reference entities.

### FIELD OF THE INVENTION

The present invention relates generally to the fields of data processing, and potentially hazardous material management.

### BACKGROUND OF THE INVENTION

Numerous modern industries employ potentially hazardous materials in their day-to-day operation, including but are not limited to the development, manufacturing and distribution of their products. Such industries include but are not limited to the semiconductor, electronic, automotive, and refining industries.

The term potentially hazardous material (PHM) as used herein refers to the broad range of materials that may raise health, safety and/or environmental issues, including in particular those, which usage requires the maintenance of corresponding material safety data sheets (MSDS). Examples of these materials include but are not limited to the materials regulated by e.g. the Environmental Protection Agency of U.S. Government.

A MSDS of a PHM typically specifies the constitutions, special handling, storage, fire fighting procedures of the PHM. Not only the special handling and storage procedures have to be followed, the MSDS data must be updated and kept current. Resultantly, PHM usage not only has to be managed, further, proper management is a cost/profit issue as well as a health, safety and environment issue. Thus, it is desirable for entities to know whether they are managing PHM usage efficiently and/or effectively, in particular, as compared to their peers/competitors. 10005J The term “entity” as used herein refers to any organization units, business or non-business, for profit or non-profit.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the invention, in accordance with various embodiments;

FIG. 2 illustrates a data organization suitable for use to implement the PHM DB of the server of FIG. 1, in accordance with various embodiments;

FIG. 3 illustrates one aspect of an user interface provided by the PHM Management Software of FIG. 1, in accordance with various embodiments;

FIG. 4a-4f illustrate a number exemplary graphical presentations provided by the PHM Management Software of FIG. 1, in accordance with various embodiments;

FIG. 5 illustrates a flow chart view of selected operations of the PHM Management Software of FIG. 1, in accordance with various embodiments; and

FIG. 6 illustrates the server of FIG. 1 in further detail, in accordance with various embodiments.

### DETAILED DESCRIPTION OF ILLUSTRATIVE EMBODIMENTS

Illustrative embodiments of the present invention include but are not limited to methods for guiding entities on managing PHM, and hardware/software endowed to practice and/or support the practice of the methods in whole or in part.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances,-well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising”, “having”, and “including” are synonymous, unless the context dictates otherwise.

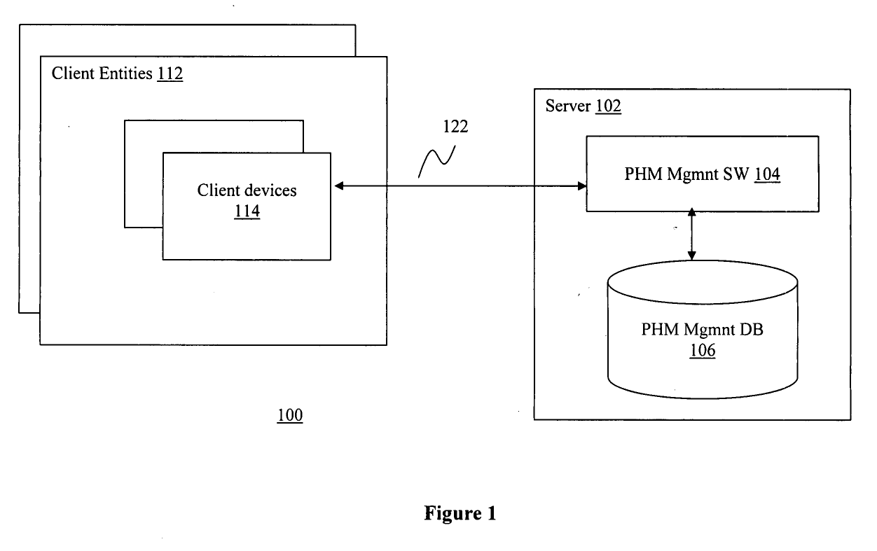

Referring now to FIG. 1, wherein an overview of the present invention, in accordance with various embodiments, is shown. As illustrated, for the embodiments, server 102 is endowed with PHM Management Software 104, which is adapted with functions to provide guidance to client site entities 112 on managing usage of PHM efficiently and/or effectively. In particular, as will be described in more detail below, PHM Management Software 104 is adapted to provide client site entities 112 with summary data on a number of PHM management issues. These summary data may be summary of the client site entities' own data, or summary of a number of reference entities' data.

In various embodiments, the reference entities may be selectable individually, by industry types, or other criteria. Further, the summary data of reference entities may be aggregated or averaged data of the reference entities.

Note that an entity may be a client site entity when acting in the role of a consumer of the gathered data, i.e. when presented with the summary data, however, the entity may be one of the reference entities, when another entity acts in the role of a client site entity. In other embodiments, an entity may be the client site entity and one of the reference entities at the same time.

Still referring to FIG. 1, as illustrated, for the embodiments, server 102 is also provided with PHM database 106 having data of the reference and client entities. In alternate embodiments, PHM database 106 may be remotely disposed away from server 102 instead.

In various embodiments, PHM Management Software 104 presents the summary data in graphical form on client devices 114. In particular, for the embodiments, PHM Management Software 104 presents the graphical summaries in the form of web pages. That is, server 102 is further endowed with a web server and various communication interfaces, whereas client devices are endowed with a browser and corresponding communication devices.

In other embodiments, the summary data may be presented in other formats, e.g. as attachment to electronic communications, as printed mailings, and so forth.

For the embodiments, client devices 114 are coupled to servers 102 via network connections 122 over a number of private and/or public networks, including but are not limited to the Internet. The communications between client devices 114 and server 102 may be conducted in accordance with one of a number of messaging protocols, including but are not limited to, e.g., the HTTP protocol (HTTP=Hypertext Transmission Protocol).

Except for PHM Management Software 104 and PHM Database 106, server 102 and client devices 114 represent a broad range of these elements known in the art, or to be designed (as long as they are consistent with the teachings of the present invention). Accordingly, except for PHM Management Software 104 and PHM Database 106, and an example of server 102, client devices 114 and coupling 122 will not be further described.

While for ease of understanding, server 102 is “singularly” illustrated, in various embodiments, server 102 may be a single computing device, a cluster of tightly coupled computing devices, or networked computing devices.

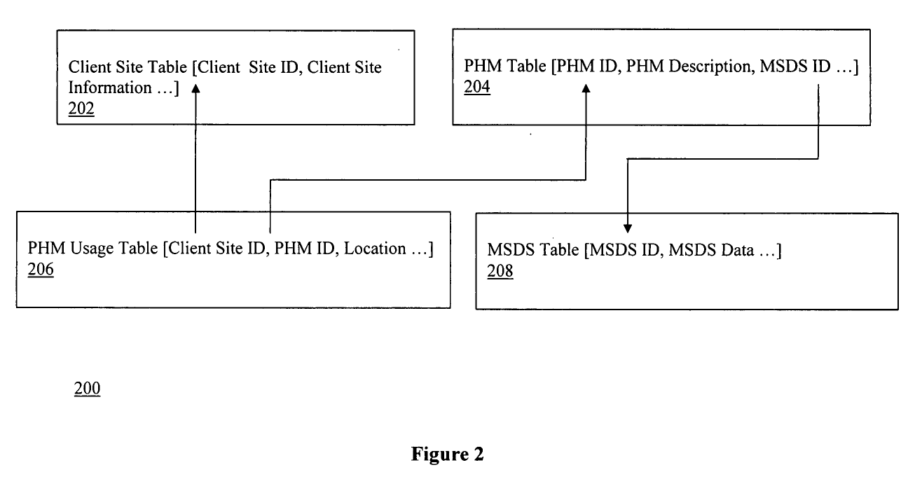

FIG. 2 illustrates a data organization suitable for use to organize data of PMH DB 106, in accordance with various embodiments. As illustrated, for the embodiments, data organization 200 includes Client Site Table 202, PHM Table 204, PHM Usage Table 206, and MSDS Table 208 logically coupled to each other as shown.

Client Site Table 202 has a number of rows for storing client data of the various client sites, one row per client site. For the embodiments, each row includes a first column for storing an identification for a client site, and one or more additional columns for storing descriptions of the client site, which may include, but are not limited to, e.g., the name of the client site, the address of the client site, the industry of the client site and so forth.

Similarly, PHM Table 204 has a number of rows for storing PHM data, one row per PHM. For the embodiments, each row includes a first column for storing an identifier of a PHM, and one or more columns for storing descriptions of the PHM, which may include, but are not limited to, e.g., an identifier type for the PHM identifier, a common name of the PHM, a manufacturer of the PHM, synonyms of the PHM, a MSDS identifier, and so forth. In various embodiments, the identifier type of a PHM identifier may be a UPC type (UPC=Uniform Product Code) or a SKU type (SKU=Stock Keeping Unit).

Likewise, PHM Usage Table 206, has a number of rows for storing PHM usage data, one row per PHM usage. For the embodiments, each row includes a first column for storing an identification of a client site using a PHM, and a second column for storing an identification or description of the PHM used.

MSDS Table 208, on the other hand, has a number of rows for storing MSDS data, one row per MSDS. For the embodiments, each row includes a first column for storing an identification of a MSDS, and a second column for storing a file identifier of a file having associated data of the MSDS, which may include, but are not limited to, e.g., the special handling procedure, the storage procedure, the fire fighting procedure, the date it was first downloaded, the data it was last updated, and so forth.

Accordingly, client site, PHM, as well as MSDS information may be readily “looked up” from Client Site, PHM and MSDS Tables 202, 204 and 206 respectively, reducing the amount of storage required to practice various embodiments of the invention.

In alternate embodiments, PHM DB 106 may be practiced with other data organizations instead.

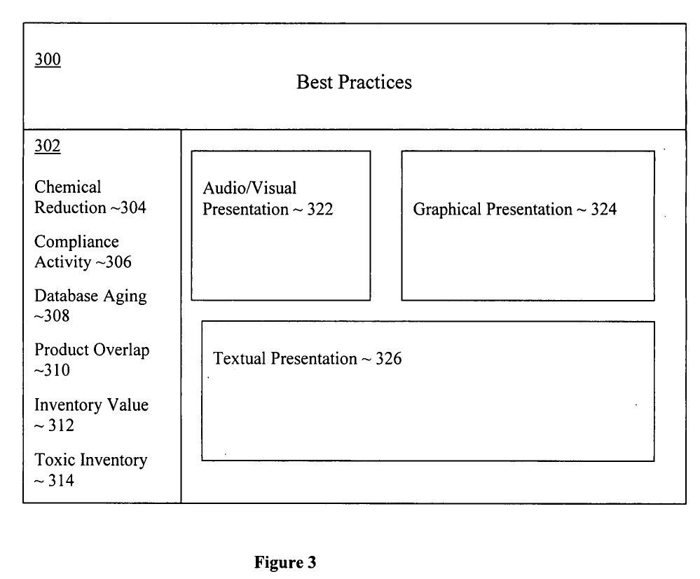

FIG. 3 illustrates one aspect of the user interface provided by PHM Management Software 104 of FIG. 1, in accordance with various embodiments. As illustrated, the user interface includes web page 300 having various sections. Section 302 provides a list of PHM management issues for a user to select. For the illustrated embodiments, the issues include Chemical Reduction, Compliance Activities, Database Aging, Product Overlap, Inventory Value and Toxic Inventory. In other embodiments, more or less PHM management issues may be supported.

For the illustrated embodiments, web page 300 further includes sections 322-326 for presenting audio/visual, graphical and textual presentations, respectively, for a selected issue. As earlier described, the presentations may be for the client site entity, a collection of client site entities, or the reference client entities, or both (e.g. comparing the client site entity or the client site entities to the reference entities). In other embodiments, more or less presentations may be supported to guide an entity on PHM management.

Selection of the underlying data (i.e. client site entity, client site entities, reference entities (including e.g. industry of the reference entities), or both) may be facilitated via any one of a number of techniques, e.g. pop-up windows, prior to or after the selection of the issue of interest. Hereinafter, a client site entity and client site entities may simply be referred to as client entity/entities.

In various embodiments, Chemical Reduction refers to how effective an entity or the reference entities are in reducing the number of chemicals used over time. In general, for most industries, especially matured industries, the more effective PHM are managed, the fewer number of chemicals are used over time.

In various embodiments, Compliance Activities refers to the volume of activities of an entity or the reference entities, for complying with various PHM regulations. These activities may include but are not limited to, the number of times the various MSDS has been printed, viewed or updated. In general, for most industries, the more effective PHM are managed, the amount of compliance activities as a ratio to the number of PHM used should be relatively stable or even declining.

In various embodiments, Database Aging refers to the currency of the entity or the reference entities' data. In general, for most industries, the more effective PHM are managed, the PHM data should be more current.

In various embodiments, Product Overlap refers to the efficiency of the entity or the reference entities in using PHM. In general, for most industries, the more effective PHM are managed, as a ratio to the number of products, the fewer number of PHM are employed.

In various embodiments, Inventory Value refers to the loaded cost of the entity or the reference entities' raw material. Loaded cost refers to adjusted cost of the PHM, when the cost of handling PHM waste is included. In general, for most industries, the more effective PHM are managed, the lower is the loaded cost.

In various embodiments, Toxic Inventory refers to the subset of PHM with particular significant toxicity. In general, for most industries, the more effective PHM are managed, the number of particular toxic PHM used, as a ratio of all PHM used, should be stable or declining. In various embodiments, PHM above certain regulatory health and/or safety classifications may be considered particular toxic. The threshold classifications may vary from industry to industry or from implementation to implementation.

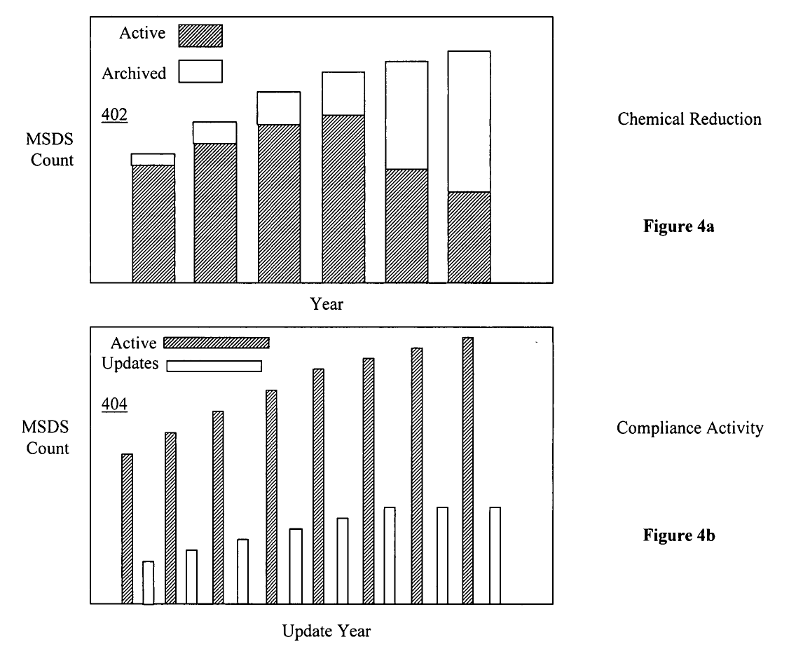

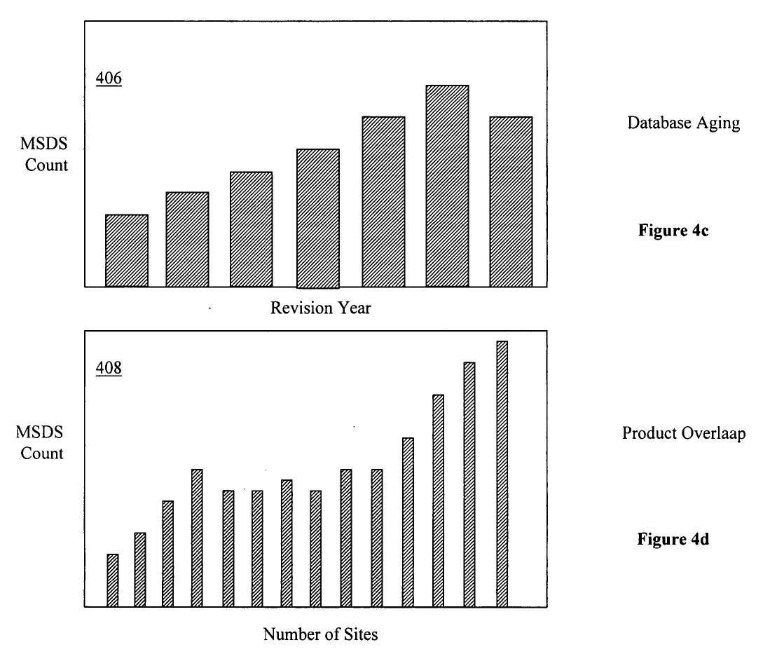

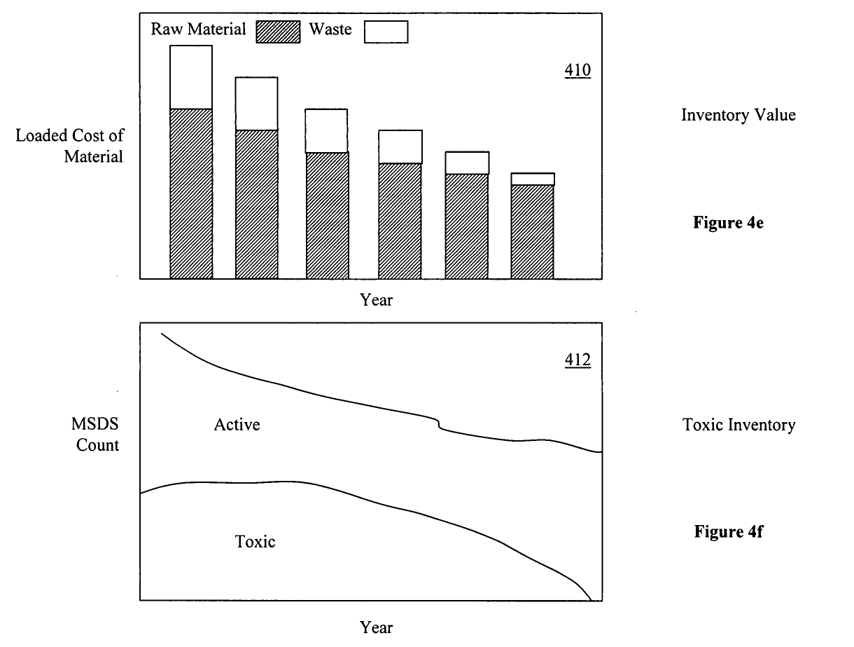

FIGS. 4a-4f illustrate various graphical presentations provided by PHM Management Software 104 of FIG. 1, in accordance with various embodiments. The various graphical presentations depict various PHM management practices of a client entity or a number of reference entities. In particular, the various graphical presentations depict the various PHM management practices of a client entity or a number of reference entities, based at least in part on MSDS data of the client entity or reference entities. For reference entities, the depiction may be based on aggregated or averaged MSDS data of the reference entities.

FIG. 4a depicts an exemplary graphical presentation having a number of bar graphs that may be employed to depict Chemical Reduction practice of the client entity or reference entities. For the example, Chemical Reduction practice is depicted by comparing the number of active MSDS to the number of archived MSDS over various years. As described earlier, for most industries, especially matured industries, the more effective PHM are managed, the fewer number of chemicals (as indicated by fewer active MSDS) are used over time.

FIG. 4b depicts an exemplary graphical presentation having a number of bar graphs that may be employed to depict Compliance Activities of the client entity or reference entities. For the example, Compliance Activities practice is depicted by comparing the number of printing, viewing, and/or updating the various MSDS to the number of active MSDS over various years. As described earlier, for most industries, the more effective PHM are managed, the amount of Compliance Activities as a ratio to the number of PHM used (as indicated by active and updated MSDS) should be relatively stable or even declining.

FIG. 4c depicts an exemplary graphical presentation having a number of bar graphs that may be employed to depict Database Aging of the client entity or reference entities. For the example, Database Aging practice is depicted by examining the age (year updated) of the various MSDS of the entity/entities. As described earlier, for most industries, the more effective PHM are managed, PHM data as indicated by the age of the MSDS should be more current.

FIG. 4d depicts an exemplary graphical presentation having a number of bar graphs that may be employed to depict Product Overlap of the client entity or reference entities. For the example, Product Overlap practice is depicted by the distribution of MSDS application to (i.e. usage of corresponding PHM by) sites of the entity/entities. As described earlier, for most industries, the more effective PHM are managed, the higher is the ratio of products to PHM employed, as indicated by application of MSDS to sites.

FIG. 4e depicts an exemplary graphical presentation having a number of bar graphs that may be employed to depict Inventory Value of the client entity or reference entities. For the example, Inventory Value practice is depicted by the loaded cost of the various materials of entity or the reference entities, over a number of years. As described earlier, for most industries, the more effective PHM are managed, the lower is the loaded cost.

FIG. 4f depicts an exemplary graphical presentation having a number of non-linear graphs that may be employed to depict Toxic Inventory of the client entity or reference entities. For the example, Toxic Inventory practice is depicted by the number of toxic materials versus the number of PHM, over a number of years. As described earlier, for most industries, the more effective PHM are managed, the number of particular toxic PHM used, as a ratio of all PHM used, should be stable or declining.

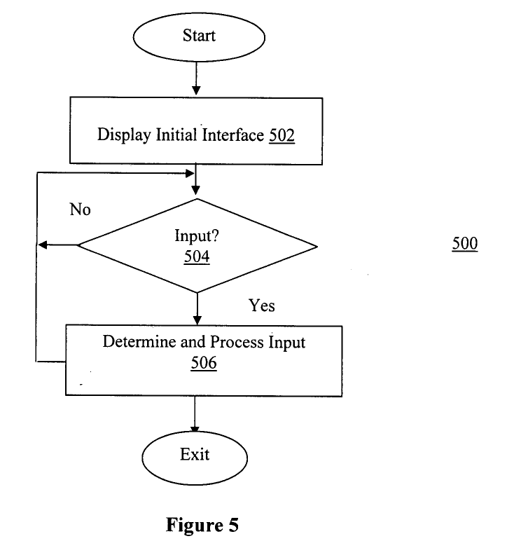

FIG. 5 illustrates a flow chart view of selected operations of PHM Management Software 104 of FIG. 1, in accordance with various embodiments. As illustrated, on start up, Software 104 causes initial user interface 300 to be rendered on a display, block 502. Thereafter, Software 104 waits for an input, e.g., selection of one of the PHM management issue, block 504.

On receipt, Software 104 determines the input, and processes the input accordingly, block 506. For examples, assuming the user has previously conveyed his/her interest in averaged data of the reference entities,
on selection of the Chemical Reduction issue, Software 104
   retrieves the applicable MSDS data (or calculating them if they've not been previously calculated), and
   then generates and renders the graphical representation;
on selection of the Inventory Cost issue, Software 104
   retrieves the applicable cost data (or calculating them if they've not been previously calculated), and
   then generates and renders the graphical representation.

In other embodiments, other processing, in addition to, or in lieu of some of the earlier described processing may be supported. In various embodiments, the additional processing includes in particular, the processing to generate, if applicable, and render audio/visual and/or textual presentations associated with the selected PHM management issue. In various embodiments, the additional processing includes in particular, an import function for importing PHM data of a client/reference entity. The import function may include the function of automatically re-calculating the summary data of the reference entities real time or in batch.

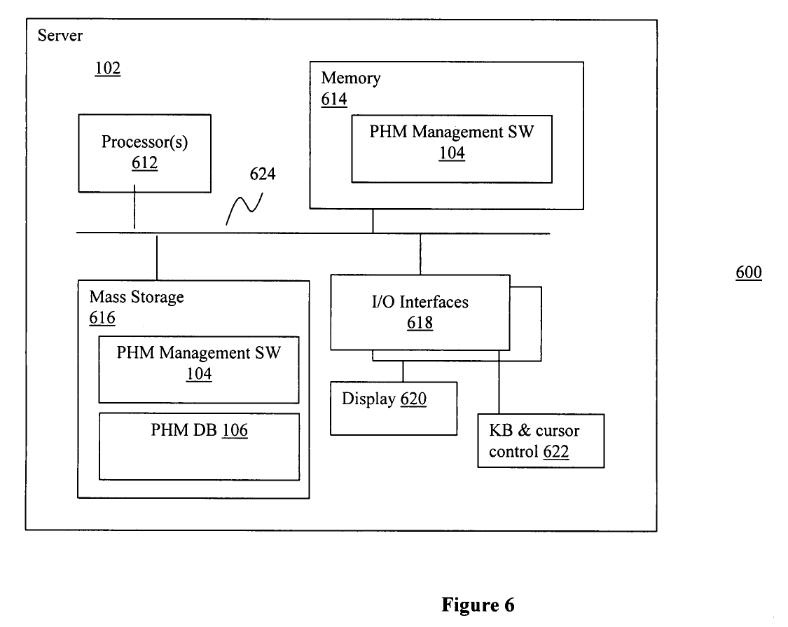

FIG. 6 illustrates an example implementation of server 102 of FIG. 1, in accordance with various embodiments. As illustrated, server 102 includes digital computing processor 612, memory 614 coupled to each other via bus 624. Further, device 612 includes mass storage device 616, I/O interfaces 618, and a number of I/O devices coupled to each other and the earlier described elements as shown. Memory 614 and mass storage device 616 include in particular, a transient and a persistent copy of PHM Management Software 104 respectively. Mass storage device 616 further includes PHM database 106. The I/O devices include in particular, display 620 and keyboard/cursor control 622.

In various embodiments, processor 612 may be any one of a number of microprocessors known in the art, or to be designed (as long as they are consistent with the teachings of the present invention), including but are not limited to, the processors available from Intel Corp., of Santa Clara, Calif.

Memory 614 may likewise be any one of a number of volatile storage known in the art or to be designed (as long as they are consistent with the teachings of the present invention), including but are not limited to, the volatile storage available from Kingston Technology of Fountain Valley, Calif. Mass storage device 616 may likewise be any one of a number of non-volatile storage known in the art or to be designed (as long as they are consistent with the teachings of the present invention), including but are not limited to, the non-volatile disk storage available from Seagate of City, Calif.

In various embodiments, I/O interfaces 618 include a communication interface for coupling server 102 to client devices 114. The communication interface may be a wire based or wireless interface, coupling server 102 to devices 114 via a wired/wireless local/wide area network. An example of a suitable wired network interface includes but is not limited to an Ethernet interface, and an example of a suitable wireless network interface includes but is not limited to an IEEE 802.11b network interface.

Except for PHM Management Software 104 (earlier described), and the manner these elements are employed, each of these elements represents a broad range of the corresponding element known in the art or to be designed, consistent with the teachings of the present invention. The elements perform their conventional functions, i.e. processing, storage, reading, displaying, and so forth.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. An apparatus comprising:
storage medium having stored therein a plurality of instructions adapted to present aggregated or averaged data associated with potentially hazardous material management of a plurality of reference entities; and
one or more processors coupled to the storage medium to execute the instructions. (

2. The apparatus of claim 1, wherein the instructions are further adapted to present data associated with potentially hazardous material management of a client site entity.

3. The apparatus of claim 1, wherein the aggregated or averaged data comprise aggregated or averaged number of chemicals used by the plurality of reference entities in various time periods.

4. The apparatus of claim 1, wherein the aggregated or averaged data comprise aggregated or averaged number of compliance activities of the plurality of reference entities in various time periods.

5. The apparatus of claim 1, wherein the aggregated or averaged data comprise aggregated or averaged hazard data currency of the plurality of reference entities.

6. The apparatus of claim 1, wherein the aggregated or averaged data comprise aggregated or averaged potentially hazardous material usage overlap among various sites of the plurality of reference entities.

7. The apparatus of claim 1, wherein the aggregated or averaged data comprise aggregated or averaged loaded cost of raw materials of the plurality of reference entities in various time periods.

8. The apparatus of claim 1, wherein the aggregated or averaged data comprise aggregated or averaged number of toxic substances used by the plurality of reference entities in various time periods.

9. The apparatus of claim 1, wherein the aggregated or averaged data comprise aggregated or averaged data associated with material safety data sheets of the plurality of reference entities in various time periods.

10. The apparatus of claim 9, wherein the aggregated or averaged data associated with the material safety data sheets of the plurality of reference entities in various time periods comprise one or more selected from the group consisting of
aggregated or averaged number of active material safety data sheets of the reference entities in the various time periods,
aggregated or averaged number of archived material safety data sheets of the reference entities in the various time periods,
aggregated or averaged number of material safety data sheets of the reference entities updated in the various time periods, and
aggregated or averaged number of material safety data sheets of the reference entities applicable to number of sites of the reference entities.

11. The apparatus of claim 1, wherein the instructions are further adapted to tabulate said aggregated or averaged data associated with potentially hazardous material management of the plurality of reference entities.

12. The apparatus of claim 11, wherein the storage medium further has stored therein pre-tabulation data associated with potentially hazardous material management of the plurality of reference entities.

13. The apparatus of claim 1, further comprising a display coupled to the storage medium and at least one of one or more processors, and the instructions are adapted to present the aggregated or averaged data on the display.

14. A method of operation in a computer system comprising:
generating or retrieving digitally aggregated or averaged data associated with potentially hazardous material management of a plurality of reference entities; and
presenting or causing to be presented on a client device, the generated or retrieved, aggregated or averaged data associated with potentially hazardous material management of the plurality of reference entities.

15. The method of claim 14, further comprising
generating or retrieving digitally data associated with potentially hazardous material management of a client entity; and
presenting or causing to be presented on a client device, the generated or retrieved data associated with potentially hazardous material management of the client entity.

16. The method of claim 14, wherein the aggregated or averaged data comprise aggregated or averaged number of chemicals used by the plurality of reference entities in various time periods.

17. The method of claim 14, wherein the aggregated or averaged data comprise aggregated or averaged number of compliance activities of the plurality of reference entities in various time periods.

18. The method of claim 14, wherein the aggregated or averaged data comprise aggregated or averaged hazard data currency of the plurality of reference entities.

19. The method of claim 14, wherein the aggregated or averaged data comprise aggregated or averaged potentially hazardous material usage overlap among various sites of the plurality of reference entities.

20. The method of claim 14, wherein the aggregated or averaged data comprise aggregated or averaged loaded cost of raw materials of the plurality of reference entities in various time periods.

21. The method of claim 14, wherein the aggregated or averaged data comprise aggregated or averaged number of toxic substances used by the plurality of reference entities in various time periods.

22. The method of claim 14, wherein the aggregated or averaged data comprise aggregated or averaged data associated with material safety data sheets of the plurality of reference entities in various time periods.

23. The method of claim 22, wherein the aggregated or averaged data associated with the material safety data sheets of the plurality of reference entities in various time periods comprise one or more selected from the group consisting of
aggregated or averaged number of active material safety data sheets of the reference entities in the various time periods,
aggregated or averaged number of archived material safety data sheets of the reference entities in the various time periods,
aggregated or averaged number of material safety data sheets of the reference entities updated in the various time periods, and
aggregated or averaged number of material safety data sheets of the reference entities applicable to number of sites of the reference entities.

24. The method of claim 14, further comprising digitally tabulating said aggregated or averaged data associated with potentially hazardous material management of the plurality of reference entities.

25. The method of claim 24, further comprising digitally storing pre-tabulation data associated with potentially hazardous material management of the plurality of reference entities.

26. A computer readable medium comprising:
storage medium;
a plurality instructions stored in the storage medium, the instructions having been adapted to program an apparatus to enable the apparatus to practice the method of claim 14.
